(19) United States
(12) Patent Application Publication
(10) Pub. No.: US 2025/0208855 A1
(43) Pub. Date: Jun. 26, 2025

(54) UPGRADE ANALYTICS

(71) Applicant: DISH Wireless L.L.C., Littleton, CO (US)

(72) Inventors: Julio Armenta, Aldie, VA (US); Amit Pathania, Great Falls, VA (US)

(21) Appl. No.: 18/990,406

(22) Filed: Dec. 20, 2024

Related U.S. Application Data
(60) Provisional application No. 63/613,495, filed on Dec. 21, 2023.

(51) Int. Cl. G06F 8/65; G06F 11/34; G06F 11/3668

(52) U.S. Cl. CPC G06F 8/65; G06F 11/3409; G06F 11/3688

(57) ABSTRACT

Devices, systems, and methods for upgrading software services are provided. An example method includes receiving an upgrade artifact to be deployed on a cloud computing platform comprising a plurality of servers, extracting a plurality of attributes from the upgrade artifact, selecting a first attribute from the plurality attributes, determining a first performance criterion associated with the first attribute, configuring an upgrade instance to meet the first performance criterion during deployment of the upgrade artifact, identifying a first group of servers associated with the first attribute from the plurality of servers, and executing the upgrade instance to deploy the upgrade artifact on the first group of servers in a production environment.

### CROSS REFERENCE TO RELATED APPLICATIONS

This application claims priority to U.S. Provisional Patent Application No. 63/613,495, filed on Dec. 21, 2023, the disclosure of which is incorporated by reference in its entirety for all purposes.

### BACKGROUND

The advent of 5G networks enables high speed, low latency, and massive connectivity to meet the growing demands of network consumers. In tandem with the evolution of 5G, the Open Radio Access Network (O-RAN) has emerged as advanced architecture of RANs. O-RAN employs open and interoperable standards and disaggregates traditional monolithic network elements into modular components. This disaggregation, coupled with standardized interfaces and virtualization, enables flexibility, scalability, and vendor diversity within RANs.

While the advancements of 5G networks empower service providers with capabilities to deploy service applications on a 5G network and provision services to end users, they also introduce unique challenges in upgrading the service applications. The dynamic nature of virtualized and disaggregated networks demands continuous adaptability. Service providers face complexities, for example, in orchestrating upgrades across virtualized components and maintaining service continuity during the evolution of 5G and O-RAN networks.

### SUMMARY

In accordance with some embodiments of the present disclosure, a method is provided. In one example, the method includes: receiving an upgrade artifact to be deployed on a cloud computing platform comprising a plurality of servers, extracting a plurality of attributes from the upgrade artifact, selecting a first attribute from the plurality of attributes, determining a first performance criterion associated with the first attribute, configuring an upgrade instance to meet the first performance criterion during deployment of the upgrade artifact, identifying a first group of servers associated with the first attribute from the plurality of servers, and executing the upgrade instance to deploy the upgrade artifact on the first group of servers in a production environment.

In accordance with some embodiments of the present disclosure, a system for software/service/application upgrade is provided. In one example, the system includes one or more processors and a computer-readable storage media storing computer-executable instructions. The computer-executable instructions, when executed by the one or more processors, cause the system to perform: receiving an upgrade artifact to be deployed on a cloud computing platform comprising a plurality of servers, extracting a plurality of attributes from the upgrade artifact, selecting a first attribute from the plurality of attributes, determining a first performance criterion associated with the first attribute, configuring an upgrade instance to meet the first performance criterion during deployment of the upgrade artifact, identifying a first group of servers associated with the first attribute from the plurality of servers, and executing the upgrade instance to deploy the upgrade artifact on the first group of servers in a production environment.

In accordance with some embodiments, the present disclosure also provides a non-transitory machine-readable storage medium encoded with instructions, the instructions executable to cause one or more electronic processors of a device or a system to perform any one of the methods described in the present disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a cellular network system, according to various embodiments.

FIG. 2 illustrates an exemplary core, according to various embodiments.

FIG. 3 illustrates an embodiment of a cellular network core network topology as implemented on a public cloud-computing platform, according to certain embodiments.

FIG. 4 illustrates an example of a service/software deployment and upgrade system according to various embodiments.

FIG. 5 is a flow diagram illustrating an example method for service/software deployment and upgrade, according to various embodiments.

FIG. 6 is a flow diagram illustrating another example method for service/software deployment and upgrade, according to various embodiments.

FIG. 7 is a schematic diagram illustrating an example computer system or computer device, according to various embodiments.

### DETAILED DESCRIPTION

The present disclosure provides methods, devices, systems, and software products generally related to deployment and upgrade of application/service/software.

A traditional approach of upgrading a service application deployed on a network or a platform that supports the network often relies on service maintenance windows for upgrades. This traditional approach, while widely employed, has drawbacks that can impact the efficiency and user experience within the network. For example, service maintenance windows impose fixed timeframes for upgrades and limit the flexibility for service providers to adapt to evolving circumstances or implement critical updates promptly. During a maintenance window, regular services are often temporarily suspended to facilitate the upgrade process. This interruption can result in downtime and causes inconvenience to end-users and potentially impacting businesses that rely on uninterrupted services. Maintenance windows may lead to underutilization of network resources during non-upgrade periods. This inefficiency arises from the necessity to allocate dedicated time for maintenance, even if the network could accommodate upgrades with minimal impact on ongoing operations. Coordinating and executing upgrades within the confines of maintenance windows can pose logistical challenges, especially in complex network infrastructures. In situations where urgent updates or fixes are required, relying on maintenance windows can result in delayed responses.

The present disclosure provides solutions to improving the deployment and upgrade process of software applications. According to some embodiments of the present disclosure, an automated, continuous, and adaptive method for the deployment of artifacts or upgrade artifacts on a cellular network or a cloud computing platform is provided. The method includes receiving an upgrade artifact to be deployed on a cloud computing platform comprising a plurality of servers, extracting a plurality of attributes from the upgrade artifact, selecting an attribute from the plurality attributes, determining a performance criterion associated with the attribute, configuring an upgrade instance to meet the performance criterion during deployment of the upgrade artifact, identifying a group of servers associated with the first attribute from the plurality of servers, and executing the upgrade instance to deploy the upgrade artifact on the first group of servers.

The method according to the present disclosure adapts to dynamic conditions by continuously monitoring and adjusting the deployment process based on selected attributes and associated performance criteria. By selecting attributes and configuring upgrade instances based on performance criteria, the method optimizes resource utilization on the cloud computing platform. The method automates the configuration of upgrade instances and eliminates the need for manual intervention. With attribute-driven customization, the deployment or upgrade process could align with specific requirements by the service provider, such as region-based considerations or network slice priorities.

Unlike the rigid time-constrained nature of the traditional maintenance windows approach, the present method advantageously allows for continuous and adaptive deployment or upgrades and can significantly reduce the downtime. This may result in enhanced service continuity, especially critical in scenarios where emergent upgrades are required, as the method can operate seamlessly without scheduled interruptions. The adaptability and attribute-driven nature of the method provide a more agile and responsive solution and can improve the overall efficiency and reliability of the deployment or upgrade process.

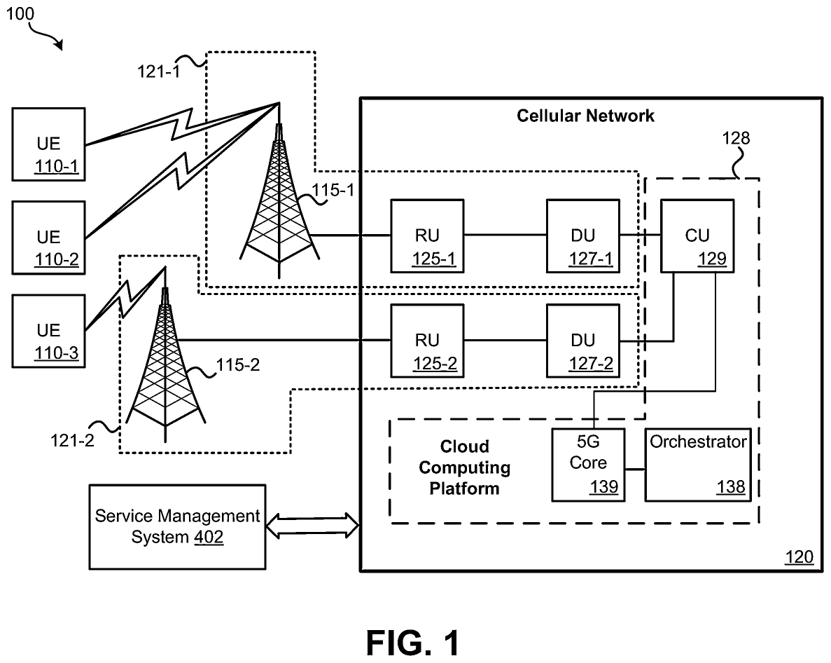

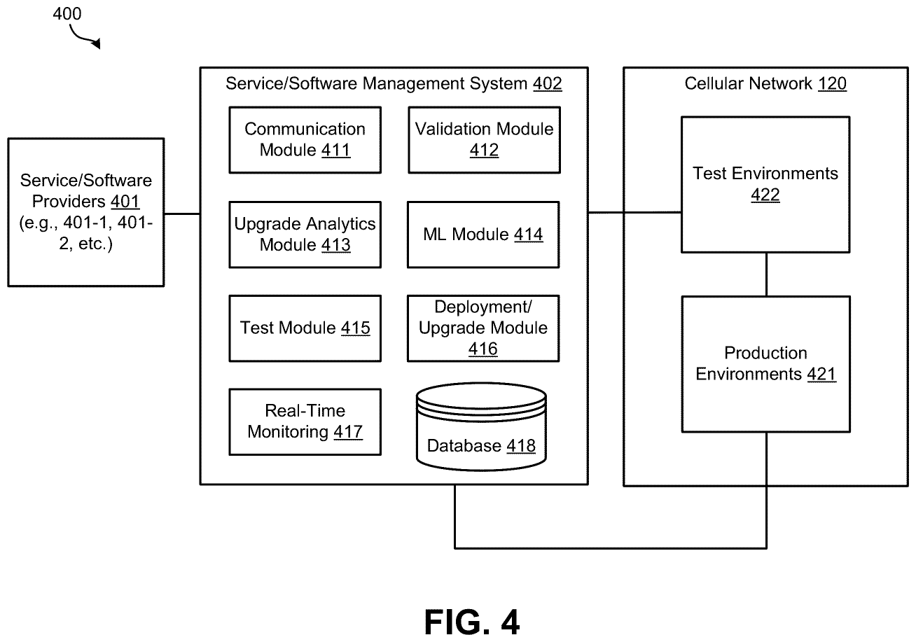

Further details regarding various embodiments of the present disclosure are provided below in relation to the figures. FIG. 1 illustrates a block diagram of a hybrid cellular network system 100 (hereinafter “system 100”). System 100 can include a 5G New Radio (NR) cellular network; as noted, other types of cellular networks, such as Long-Term Evolution (LTE), Sixth-Generation (6G), Seventh-Generation (7G), etc., may also be possible. System 100 can include: user equipment (UE) 110 or (UE 110-1, UE 110-2, UE 110-3); structure 115; cellular network 120; radio units 125 (“RUs 125”); distributed units 127 (“DUs 127”); centralized unit 129 (“CU 129”); 5G core 139; orchestrator 138, and an access on-demand provider 140. System 100 further includes a service management system 402, which will be described below with reference to FIG. 4.

FIG. 1 represents a component-level view. In an open radio access network (O-RAN), because components can be implemented as specialized software executed on general-purpose hardware, except for components that need to receive and transmit RF, the functionality of the various components can be executed by general-purpose servers. For at least some components, the hardware may be maintained by a separate cloud-service computing platform provider. Therefore, the cellular network operator may operate some hardware, such as RUs and local computing resources on which DUs are executed, such components may be connected with a cloud-computing platform on which other cellular network functions, such as the core and CUs are executed.

UE 110 can represent various types of end-user devices, such as cellular phones, smartphones, cellular modems, cellular-enabled computerized devices, sensor devices, robotic equipment, IoT devices, gaming devices, access points (APs), or any computerized device capable of communicating via a cellular network. More generally, UE can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, UE 110 may use RF to communicate with various BSs of cellular network 120. As illustrated, two BSs are illustrated: BS 121-1 can include: structure 115-1, RU 125-1, and DU 127-1. Structure 115-1 may be any structure to which one or more antennas (not illustrated) of the BS are mounted. Structure 115-1 may be a dedicated cellular tower, a building, a water tower, or any other man-made or natural structure to which one or more antennas can reasonably be mounted to provide cellular coverage to a geographic area. Similarly, BS 121-2 can include: structure 115-2, RU 125-2, and DU 127-2.

Real-world implementations of system 100 can include many (e.g., thousands) of BSs and many CUs and 5G core 139. BS 121-1 can include one or more antennas that allow RUs 125 to communicate wirelessly with UEs 110. RUs 125 can represent an edge of cellular network 120 where data is transitioned to RF for wireless communication. The radio access technology (RAT) used by RU 125 may be 5G NR, or some other RAT. The remainder of cellular network 120 may be based on an exclusive 5G architecture, a hybrid 4G/5G architecture, or some other cellular network architecture that supports cellular network slices. BS 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 127-1, may communicate with CU 129. Collectively, RUs, DUs, and CUs create a gNodeB, which serves as the radio access network (RAN) of cellular network 120. CU 129 can communicate with core 139. The specific architecture of cellular network 120 can vary by embodiment. Edge cloud server systems outside of cellular network 120 may communicate, either directly, via the Internet, or via some other network, with components of cellular network 120. For example, one or more DUs 127-1 may be able to communicate with an edge cloud server system without routing data through CU 129 or core 139.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

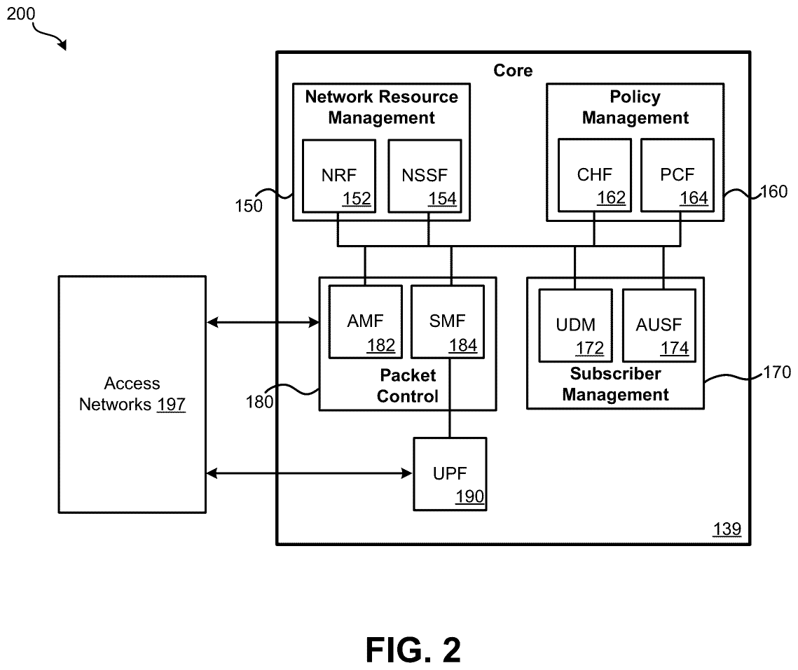

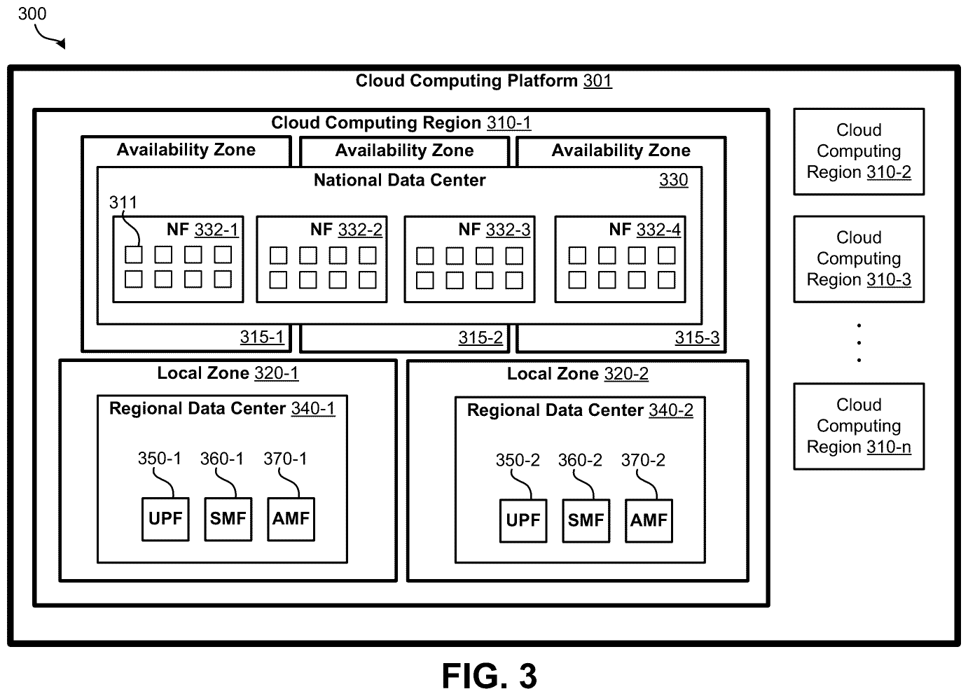

Further detail regarding exemplary core 139 is provided in relation to FIG. 1. FIG. 2 illustrates an exemplary core 139, according to certain embodiments. The exemplary core 139 can be physically distributed across data centers or located at a central national data center (NDC), such as detailed in relation to FIG. 3, can perform various core functions of the cellular network. Core 139 can include: network resource management components 150; policy management components 160; subscriber management components 170; and packet control components 180. Individual components may communicate via a bus, thus allowing various components of core 139 to communicate with each other directly. Core 139 is simplified to show some key components. Implementations can involve additional components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE (e.g., UEs 110 of FIG. 1).

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UEs.

Packet control components 180 can include: Access and Mobility Management Function (AMF) 182 and Session Management Function (SMF) 184. AMF 182 can receive connection- and session-related information from UEs and is responsible for handling connection and mobility management tasks. SMF 184 is responsible for interacting with the decoupled data plane, creating updating and removing Protocol Data Unit (PDU) sessions, and managing session context with the User Plane Function (UPF).

User plane function (UPF) 190 can be responsible for packet routing and forwarding, packet inspection, quality of service (QoS) handling, and external PDU sessions for interconnecting with a Data Network (DN) (e.g., the Internet) or various access networks 197. Access networks 197 can include the RAN of cellular network 120 of FIG. 1.

While FIGS. 1-2 illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

Returning to FIG. 1, some O-RAN implementations of the DUs 127, CU 129, core 139, and/or orchestrator 138 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, Docker®, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU for test, orchestrator 138 can perform a pipeline of calling the DU code from a software repository incorporated as part of, or separate from cellular network 120, pulling corresponding configuration files (e.g., helm charts), creating Kubernetes nodes/pods, loading DU containers, configuring the DU, and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

In some embodiments, the network slice is a core network slice. In some embodiments, the network slice is a RAN slice. A core network slice used herein refers to a virtualized portion of the core network infrastructure that operates as an independent and isolated network. The core network slices are created to serve specific services, applications, or user groups with distinct requirements. The core network slice encompasses virtualized network functions (VNFs) and services, such as authentication, routing, session management, and policy enforcement, which are deployed to meet the specific needs of the services or applications running within the core network slice. The RAN slice used herein refers to a virtualized segment of the RAN, which includes the base stations, antennas, and other radio access elements. The RAN slice may operate as an independent network, allowing dedicated resources and services to be allocated to specific applications, user groups, or UE.

Particular network slices may only be reserved in particular geographic regions. For instance, a first set of network slices may be present at RU 125-1 and DU 127-1; and a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 1, UE 110 may be operating on one or more production network slices of cellular network 120. As detailed later in this document, a UE that functions on a particular entity's local network may be assigned to a slice particular to the entity or a slice that provides a particular QoE for tasks to be performed by the entity's UE.

Components such as DUs 127, CU 129, orchestrator 138, and core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 3 illustrates an embodiment of a cellular network core network topology 300 (hereinafter “topology 300”) as implemented on a cloud-computing platform, according to certain embodiments. The topology 300 can be an implementation of the core 139 of FIG. 1 and/or 2. Topology 300 can represent how logical cellular network groups are distributed across cloud computing infrastructure of cloud computing platform 301. Cloud computing platform 301 can be logically and physically divided up into various different cloud computing regions 310. Each of cloud computing regions 310 can be isolated from other cloud computing regions to help provide fault tolerance, fail-over, load-balancing, and/or stability and each of cloud computing regions 310 can be composed of multiple availability zones, each of which can be a separate data center located in general proximity to each other (e.g., within 600 miles). Further, each of cloud computing regions 310 may provide superior service to a particular geographic region based on physical proximity. For example, cloud computing region 310-1 may have its datacenters and hardware located in the northeast of the United States while cloud computing region 310-2 may have its datacenters and hardware located in California. For simplicity, the details of the cellular network as executed in only cloud computing region 310-1 is illustrated. Similar components may be executed in other cloud computing regions of cloud computing regions 310 (310-2, 310-3, . . . 310-n).

In some embodiments, cloud computing platform 301 may be a public cloud computing platform. In other embodiments, cloud computing platform 301 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 310 may include multiple availability zones 315. Each of availability zones 315 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 315. For example, a database that is maintained as part of NDC 330 may be replicated across availability zones 315; therefore, if an availability zone of the cloud computing region is unavailable, a copy of the database remains up-to-date and available, thus allowing for continuous or near continuous functionality.

On a (e.g., public) cloud computing platform, cloud computing region 310-1 may include the ability to use a different type of data center or group of data centers, which can be referred to as local zones 320. For instance, a client, such as a provider of the hybrid cloud cellular network, can select from more options of the computing resources that can be reserved at an availability zone 315 compared to a local zone 320. However, a local zone 320 may provide computing resources nearby geographic locations where an availability zone 315 is not available. Therefore, to provide low latency, certain network components, such as regional data centers 340, can be implemented at local zones 320 rather than availability zones 315. In some circumstances, a geographic region can have both a local zone 320 and an availability zone 315.

In the topology of a 5G NR cellular network, 5G core functions of core 139 can logically reside as part of a national data center (NDC) 330. NDC 330 can be understood as having its functionality existing in cloud computing region 310-1 across multiple availability zones 315. At NDC 330, various network functions, such as NFs 332, are executed. For illustrative purposes, each NF 332, whether at NDC 330 or elsewhere located, can be comprised of multiple sub-components, referred to as pods (e.g., pod 311) that are each executed as a separate process by the cloud computing region 310. The illustrated number of pods 311 is merely an example; fewer or greater numbers of pods 311 may be part of the respective 5G core functions. It should be understood that in a real-world implementation, a cellular network core, whether for 5G or some other standard, can include many more network functions. By distributing NFs 332 across availability zones 315, load-balancing, redundancy, and fail-over can be achieved. In local zones 320, multiple regional data centers 340 can be logically present. Each of regional data centers 340 may execute 5G core functions for a different geographic region or group of RAN components. As an example, 5G core components that can be executed within an RDC, such as RDC 340-1, may be: UPFs 350, SMFs 360, and AMFs 370. While instances of UPFs 350 and SMFs 360 may be executed in local zones 320, SMFs 360 may be executed across multiple local zones 320 for redundancy, processing load-balancing, and fail-over.

The cloud computing platform 301 may include a plurality of servers operating on the platform 301. Various service applications and software applications are deployed and/or upgraded on the servers of the cloud computing platform 301. The server of cloud computing platform 301 or the cellular network 120 sometimes also refers to a virtualized machine (VM) or virtualized server that operates as an independent instance with its own allocated computing resources, including CPU, memory, storage, and network interfaces. Examples of server include but are not limited to compute servers (workload servers), management servers, orchestration servers, storage servers, network servers (e.g., load balancers, firewall servers), database servers, authentication and authorization servers, monitoring servers, backup and recovery servers, containers, pods, and so on.

FIG. 4 illustrates an exemplary system 400 for deployment and upgrade of software/service/application, according to various embodiments. In the illustrated example, system 400 includes a service management system 402. The service management system 402 may be implemented virtually as software being executed by general-purpose computing device. Alternatively, the service management system 402 may include both hardware components and software components executed on the hardware components. The service management system 402 is in communication with the various service providers 401 and the cellular network 120. The service providers 401 develop software or service application and deploy the software or service application on one or more servers of a target network (e.g., the cellular network 120) or a target cloud computing platform (e.g., the cloud computing platform 128 that supports the core 139 of the cellular network). The software or service application may be a 5G network function, a network support function, or a specific service application. The service management system 402 is operable to manage the deployment, maintenance, and upgrade of the software and service application. In some embodiments, the service management system 402 is operated by the network operator or administrator of the cellular network 120. Alternatively, the service management system 402 may operate as an independent entity.

In some embodiments, the service providers (also referred to as service vendors) 401 may be third-party service providers specialized in developing software/applications/services using Continuous Integration and Continuous Deployment (CI/CD) methodologies and deploying them on the cellular network 120. As a brief example, developers of a service providers 401 may use a version control system to manage source codes of the new application or service, set up repositories and branches to enable code versioning, and configure a selected CI tool to automatically trigger builds when code changes are pushed to the repository. Build scripts or configuration files (e.g., YAML) can be generated and defined to specify the required build steps, dependencies, and environment configurations. Unit tests are incorporated into the CI pipeline to verify the correctness and functionality of individual components or units within the new application or new service. Static code analysis tools may be used to analyze code quality, identify potential issues, and enforce coding standards. Once the new application or new service is built, the complied code and any required dependencies may be packaged into an artifact in a deployable format. A version number may be assigned to the generated artifact. Relevant metadata and documentation may be included in the artifact. The metadata may include details like the artifact name, version, release notes, licensing information, authorship, and any other pertinent information that helps consumers of the artifact understand its purpose and usage. In some embodiments, the artifact generation process may be automated within the CI/CD pipeline. After successfully building and packaging the new application or new service, the artifact is automatically generated and versioned.

The artifact refers to a packaged and versioned software component or set of files that are ready for deployment to a target environment and contains the necessary files, configurations, dependencies, and any other resources required to execute the software application or service in the target environment. The artifact may take various forms such as binary packages, archive files, container images (Docker images or images), configuration files, database scripts, and so on. The images encapsulate the application code, dependencies, and configurations in a portable and self-contained unit that can be deployed and run on container platforms. In some embodiments, a service may include multiple artifacts, and each artifact within the application service may contribute to a certain functionality of the application service. In some embodiments, the application service provided by the service vendor is a Software as a Service (SaaS) application.

In some embodiments, an artifact may be an upgrade/update version of an artifact (hereinafter “upgrade artifact) that has been deployed on the cellular network 120. The “upgrade artifact” represents a new version or iteration of the original artifact, typically including improvements, bug fixes, new features, updated versions, new builds, or other modifications. The process of upgrading an artifact may include replacing the current deployed version with the upgraded version such that the latest and most optimized software is deployed on the network.

In the illustrated example of FIG. 4, the service management system 402 further includes communication module 411, validation module 412, upgrade analytics module 413, machine learning (ML) module 414, test module 415, deployment/upgrade module 416, real-time performance monitoring module 417, and database 418. The communication module 411 is configured facilitate communication with the service provider 410. In some embodiments, the communication module 411 includes application programing interface (API) configured to receive an artifact or an upgrade artifact from the service provider 401. The API may provide a defined interface (with a standardized set of rules and protocols) for the service provider 401 to transmit artifacts (initial software or service versions) and upgrade artifacts (subsequent versions) to the service management system 402.

The validation module 412 is responsible for checking and validating the artifact or upgrade artifact received in the service management system 402. The validation module 412 may checks the integrity of the received artifact data, validate that the artifact or upgrade artifact adheres to the specified format and structure required for integration with the cellular network 120 or the cloud computing platform 128, verify the compatibility of the artifact or upgrade artifact with the existing network infrastructure, check whether the artifact or upgrade artifact aligns with the specifications and configurations of the targeted environment, validate any accompanying metadata (e.g., version information) or instructions (e.g., deployment or upgrade instructions, or any specific details relevant to the deployment or upgrade process) associated with the artifact or upgrade artifact, check version information to confirm that the upgrade artifact corresponds to a valid and higher version than the currently deployed artifact, and communicate a validation status to the service management system 402, indicating whether the artifact or upgrade artifact has passed or failed validation.

The upgrade analytics module 413 is responsible for performing analysis on the artifact received in the service management system 402. The upgrade analytics module 413 may automatically perform the analysis upon a validation status indicating that the artifact or upgrade artifact has passed validation. The analysis may include identifying/determining one or more attributes associated with an artifact or upgrade artifact on the cellular network 120 or the cloud computing platform 128. The attributes include but are not limited to relationship such as neighbor, regions, geolocation, service provider; key performance indicators (KPIs) such as traffic, load, capacity, utilization; relevant hardware; artifact version, relevant network slice, relevant end user or user group, relevant feature, election, and so on.

For example, the upgrade analytics module 413 can identify/determine neighboring elements or components that may be affected by the deployment or upgrade, the geographical regions impacted by the deployment or upgrade, as well as different service providers involved in the cellular network or on the cloud computing platform. The upgrade analytics module 413 can access/predict performance metrics such as the current and expected traffic patterns in the network, the load on the network and sufficiency of capacity for the deployment or upgrade, and the utilization of hardware resources (e.g., computing resources, storage recourse, network resources, etc.) before and during deployment or upgrade. The upgrade analytics module 413 can also identify the specific hardware components affected by the deployment or upgrade, determine the version of the artifact or upgrade artifact to be deployed or upgraded, identify/determine the network slice associated with the to-be-deployed or to-be-upgraded artifact. The upgrade analytics module 413 may assess the geographical implications of the deployment or upgrade, identify the end users or user groups affected by the deployment or upgrade, analyze specific features impacted by the deployment or upgrade.

In some embodiments, the upgrade analytics module 413 can extract attributes from the artifact or upgrade artifact from the service provider as well as the instruction for deployment or upgrade provided by the service provider. In some embodiments, the upgrade analytics module 413 can prioritize attributes based on their significance and potential impact on the deployment or upgrade process. For instance, the instruction may specify a series of performance criteria, such as minimal user impact, maximum traffic (or a predetermined threshold of traffic), maximum load (or a predetermined threshold of load), maximum capacity (or a predetermined threshold of capacity), maximum utilization (or a predetermined threshold of utilization), and so on. The instruction may further specify the priority of these performance criteria. The upgrade analytics module 413 may prioritize attributes based on the priority of the related performance criteria (e.g., user experience, traffic, load, capacity, and utilization).

The ML module 414 is responsible for training one or more ML models. The ML modules may be used for configuring a deployment or upgrade instance, based on the attributes associated with the to-be-deployed artifact or the to-be-upgraded artifact. In once example, the ML module 414 may collect historical data on past deployment or upgrade processes, including associated attributes and outcomes, preprocess the extracted attributes from the to-be-deployed or to-be-upgraded artifact instructions, label the historical data with outcomes related to each deployment or upgrade process, for example, categorizing outcomes as successful, partially successful, or unsuccessful based on predefined criteria, engineer features extracted from the dataset, select an appropriate ML model, train the selected ML model using the preprocessed dataset to learn patterns and relationships between attributes and deployment outcomes, fine-tune the hyperparameters of the ML models to optimize their performance, validate the trained models using cross-validation techniques, evaluate the ML models' performance metrics, such as accuracy, precision, recall, and F1-score.

The ML models described herein may include one or more supervised, unsupervised, or semi-supervised ML models. Generally, supervised learning entails the use of the training dataset as discussed herein that may be used to labeled outcomes (e.g., success or failure of past deployments/upgrades) and predict a specific outcome based on input features (e.g., predicting the success of a deployment based on artifact attributes). Labeled data may include both input features (attributes) and corresponding outcomes. The ML model is trained to learn the mapping between input features and labeled outcomes. Common algorithms include decision trees, random forests, support vector machines, and neural networks. During deployment, the ML model predicts the likely outcome based on the input features, guiding the configuration of the deployment or upgrade. Unsupervised techniques, on the other hand, do not require a training set of labels. While a supervised ML model may determine whether previously seen patterns in a training dataset have been correctly labeled in a testing dataset, an unsupervised model may instead determine whether there are sudden changes in values of the plurality of data points. Semi-supervised ML models take a middle ground approach that uses a greatly reduced set of labeled training data as known in the art.

The ML module 414 may employ the trained ML models to configure a deployment or upgrade instance for deploying a new artifact or upgrading a deployed artifact on the cellular network or a cloud computing platform. In some embodiments, the ML module 414 may perform: identifying attributes extracted from the artifact or upgrade artifact, prioritizing the identified attributes (e.g., based on instruction provided by the service provider), selecting a first attribute having a first priority rank, identifying a first group of servers of the target network or cloud computing platform associated the first attribute, and triggering the initialization of deployment or upgrade of the artifact on the first group of servers of the target network or target cloud computing platform. The ML module 414 may further perform: determining that the first priority rank is the highest priority rank, configuring the deployment or upgrade instance to initialize deployment or upgrade of the artifact on the first group of servers before initializing deployment of upgrade of the artifact on the other servers of the cloud computing platform. The ML module 414 may further perform: selecting a second attribute having a second priority rank lower than the first priority rank, identifying a second group of servers of the target network or cloud computing platform associated with the second attribute, and triggering the initialization of deployment of the artifact or upgrade artifact on the second group of servers of the target network or target cloud computing platform, after the deployment of the artifact or upgrade artifact on the first servers is initialized.

In some embodiments, the ML module 414 may optimize the deployment process to meet a specific performance criterion set by the service provider, for example, a minimal user impact, a maximum number of traffic flow count (or a predetermined threshold of traffic flow count), a maximum network load (or a predetermined threshold of network load), a maximum capacity (or a predetermined threshold of capacity), a maximum resource utilization (or a predetermined threshold of resource utilization), and so on. In some embodiments, the ML module 414 may generate/output a configuration script that specifies the process of the deployment or upgrade. The configuration script may include a sequence or order of the group of servers for the deployment of upgrade process to follow.

The test module 415 is configured to generate a test environment and test the to-be-deployed artifact or to-be-upgraded artifact in the test environment 422 before deployment of the artifact or upgrade artifact in the production environment 421. Test environment 422 is a controlled and isolated environment that mimics aspects of the production environment but allows testing without affecting live users or systems. The test module 415 may generate a set of test cases that cover different aspects of the artifact's functionality for validation of the associated software's features, performance, and reliability. The test module 415 may create or acquire test data that simulates real-world scenarios and evaluate how the software's functional performance. The test module 415 may utilize automated testing tools and scripts to execute a predefined set of tests. Various tests may be performed, including regression testing to check whether new changes or upgrades introduce unintended side effects or break existing functionalities, performance testing to access how the software performs under different loads and conditions, security testing to check whether the software complies with security standards, among others.

In some embodiments, the test module 415 automatically executes the configuration script generated by the ML module 414 to deploy the artifact or upgrade artifact in the generated test environment 422, once initialization of the deployment process is triggered by the ML module 414. The test module 415 may monitor the performance of the deployment or upgrade process and obtain test performance metrics data. The test module 415 may analyze the test performance metrics data to determine whether the test performance meets the predetermined performance criterion associated with the identified attribute. The test performance metrics data may include test traffic flow data, test load data, test capacity data, test utilization data, among others.

The deployment/upgrade module 416 is responsible for deploying the artifact or upgrade artifact in production environment 421. In some embodiments, the deployment/upgrade module 416 automatically executes the configuration script generated by the ML module 414 in the production environment 421, once initialization of the deployment process is triggered by the ML module 414.

The real-time monitoring performance module 416 is responsible for monitoring the deployment or upgrade process, obtain real-time performance metrics data, such as traffic data, load data, capacity data, utilization data. The real-time monitoring performance module 416 may analyze the obtained data and determine whether the performance meets the target performance criterion (e.g., whether the traffic flow is maintained below the predetermined threshold, etc.). The real-time performance monitoring module 416 may further generate a notification to indicate an issue regarding the deployment process.

Database 418 is responsible for storing various data and files received in and generated by the service management system 402, including the artifact or upgrade artifact, instruction, attribute data, prioritization data (e.g., priority list, priority ranks, etc.), performance criteria data, configuration script, test performance metrics data, real-time performance metrics data, among others.

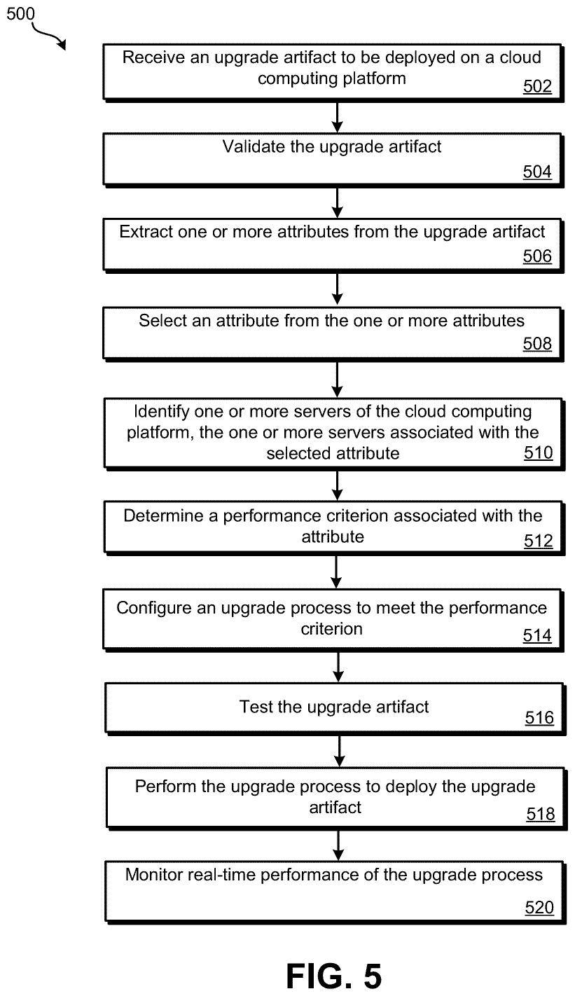

FIG. 5 is a flow chart illustrating an example method 500 for deployment of an artifact or upgrade artifact, according to various embodiments. Method 500 may be performed by system 400, or any components thereof such as the service management system 402, as described above. Depending on the implementation, method 500 may include additional, fewer, or alternative steps/operations performed in various orders or in parallel. Method 500 or any operations thereof may be combined with other methods or processes described herein in any suitable manner.

At 502, an artifact or upgrade artifact is received in the service management system. The artifact or upgrade artifact is to be deployed on a cellular network or a cloud computing platform that supports the cellular network. In some embodiments, an instruction accompanying the artifact or upgrade artifact is also received from the service provider. At 504, the received artifact or upgrade artifact is validated. In some embodiments, a validation status is generated indicating whether the artifact or upgrade artifact is validated or not.

At 506, one or more attributes from the upgrade artifact are extracted from the artifact or upgrade artifact and/or the instruction. In some embodiments, the one or more attributes associated with the artifact may include: neighbor, region, geolocation, service provider, traffic, load, capacity, utilization, hardware, artifact version, network slice, relevant end user or user group, relevant feature, election, among others.

In the context of attributes associated with the artifact or upgrade artifact, “neighbor” refers to a virtual or physical instance closely connected to the deploying or upgraded software artifact. Neighbors may share dependencies or interactions with the deployed components. “Region” refers to a distinct geographic area containing data centers and providing availability for deploying or upgrading software across multiple locations. Regions may encompass the cloud computing region 310, availability zone 315, local zone 320, national data center 330, regional data center 340, edge data center, end point data center, and so on. “Geolocation” refers to specifying the physical location or data center where the artifact or upgrade artifact may be deployed. “Traffic” refers to the volume of data (or number of traffic flows) transmitted over the network during the deployment or upgrade process. Traffic may include communication between cloud components, data transfer, and interactions with external services. “Load” refers to the demand or resource utilization imposed on the cloud computing platform during the software upgrade process and encompasses factors such as CPU load, memory usage, and network load. “Capacity” refers to the maximum workload that the cloud computing platform can handle during the deployment or upgrade. “Utilization” refers to the percentage of resources currently in use during the deployment or upgrade process. “Hardware” refers to the virtualized computing resources, including computing power, storage, and network components, necessary for deploying or upgrading the software artifact. “Relevant feature” refers to a specific functionality within the software artifact that is significant for the deployment or upgrade. “Election” refers to a process of selecting a primary instance or node responsible for orchestrating the deployment or upgrade process across the cloud computing platform. “Relevant end user or user group” refers to the individual or group who are impacted by the upgraded software artifact or benefit from the new features or improvements.

At 508, at least one attribute is selected from the extracted attributes. In some embodiments, the one or more extracted attributes are prioritized, based on the instruction provided by the service provider. The prioritized attribute or the attribute having the highest priority rank is selected.

At 510, one or more servers of the cloud computing platform are identified. The identified servers are associated with the selected attribute. For example, the attribute is a region of the cloud computing platform where the artifact or upgrade artifact is to be deployed. The region is identified, and the servers in that region are identified. In another example, the attribute is a network slice where the artifact or upgrade artifact is to be deployed. The network slice is identified, and the servers associated with the network slice are also identified.

At 512, a performance criterion associated with each attribute is determined. In some embodiments, the performance criterion is predetermined and provided by the service provider. In some embodiments, the performance criterion is determined based on the conditions of the cloud computing platform and/or the cellular network.

In one embodiment, the attribute is traffic, and a performance criterion associated with the traffic may be a maximum threshold for the traffic flow during a specific time period. In one embodiment, the attribute is the region where the artifact or upgrade artifact is to be deployed, and a performance criterion associated with the region may be latency or response time between the deployed artifact and end-users within that region. The performance criterion could specify a maximum threshold for the latency or response time. In one embodiment, the attribute is utilization, and a performance criterion associated utilization may specify that the deployed artifact or upgrade artifact should not exceed a predetermined threshold of resource utilization, such as CPU usage, memory consumption, or network bandwidth, during specific periods of high demand or traffic. In one embodiment, the attribute is network slice, and a performance criterion associated with the network slice may be related to the efficiency, reliability, or quality of service provided by that specific network slice. For example, the performance criterion may specify that the network slice should consistently deliver a high level of service reliability and throughput to end-users within the defined network slice. For another example, the performance criterion may specify that the network slice should maintain a minimum threshold for reliability (low packet loss, low latency) and throughput (data transfer speed) during the deployment or upgrade process within that network slice. It should be noted that the embodiments described herein are not intended to be limiting, and other possible attributes and associated performance criteria are also within the scope of the present disclosure.

At 514, a deployment or upgrade instance for deploying the artifact or upgrade artifact is configured according to the determined performance criteria. In some embodiments, parameters for deployment of the artifact or upgrade artifact specifically on the identified servers of the cloud computing platform are selected and configured to meet the requirement specified in the determined performance criterion associated with the selected attribute. In some embodiments, a configuration script may be generated to include the configured parameters for the deployment or upgrade instance.

At 516, the artifact or upgrade artifact may be tested. In some embodiments, a test environment that mimics the production environment is generated and configured. The deployment of the artifact or upgrade artifact is initiated by executing the configuration script within this controlled test environment. A set of test cases is executed to access the artifact or upgrade artifact's functionality, performance, and reliability. In some embodiments, the artifact or upgrade artifact is tested in the test environment to obtain test performance metrics data. The test performance metrics data is analyzed and used to determine whether the test performance meets the predetermined performance criterion associated with the identified attribute. The test performance metrics data may include test traffic flow data, test load data, test capacity data, and test utilization data, among others.

An output is generated from the testing process. The output contains detailed test results, indicating whether the artifact or upgrade artifact successfully meets predefined criteria. If, during testing, the artifact or upgrade artifact fails to meet expectations, the deployment or upgrade instance is subject to reconfiguration. This may involve reconfiguring the deployment parameters and, if necessary, modifying or updating the configuration script accordingly. For example, the configuration script may be adjusted based on identified issues, and the updated script is executed to initiate a retest within the controlled test environment. This iterative testing and refinement cycle may be repeated until the output confirms a successful pass.

At 518, once the artifact or upgrade artifact successfully passes the test, the deployment or upgrade instance is executed to introduce the artifact or upgrade artifact into the production environment. In certain embodiments, the validated configuration script is precisely executed within the production environment. In some embodiments, the artifact or upgrade artifact is automatically deployed on the group of servers associated with the attribute having the highest priority rank, before deployed on other servers of the cloud computing cloud.

At 520, real-time performance of the deployment or upgrade process is monitored. In some embodiments, real-time performance metrics data is obtained and analyzed, and a determination is made on whether the performance metrics data meet the pre-determined performance criteria. The performance metrics data may include traffic flow data, load data, capacity data, and utilization data, among others.

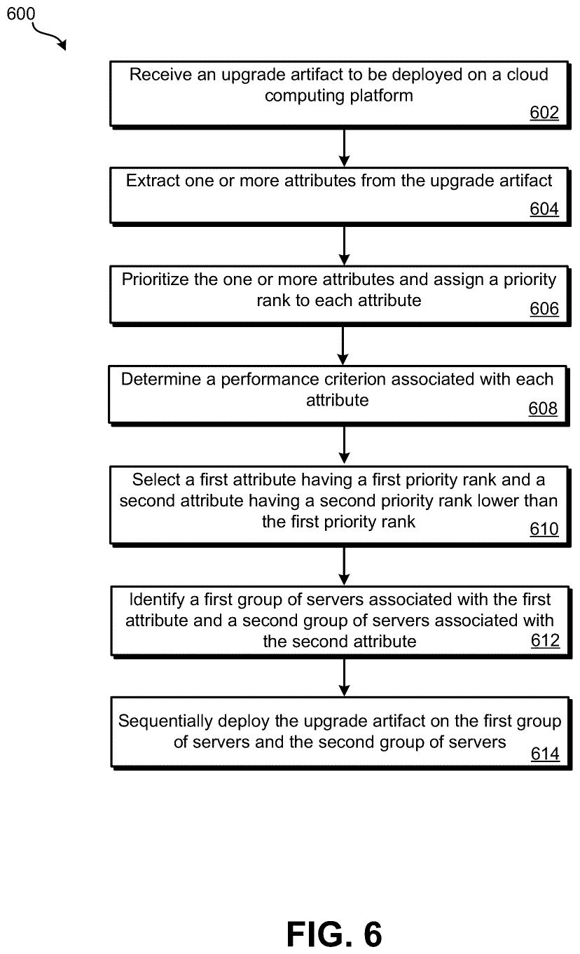

FIG. 6 is a flow chart illustrating another example method 600 for deployment of an artifact or upgrade artifact, according to various embodiments. Method 600 is a variation of method 500 and may include similar operations/steps. Depending on the implementation, method 600 may include additional, fewer, or alternative steps/operations performed in various orders or in parallel. Method 600 or any operations thereof may be combined with other methods or processes described herein in any suitable manner.

At 602, an artifact or upgrade artifact is received in the service management system. At 604, one or more attributes from the upgrade artifact are extracted from the artifact or upgrade artifact and/or the instruction. At 606, the one or more attributes are prioritized, and a priority list is generated. A priority rank is assigned to each attribute.

At 608, a performance criterion for each one of the attributes is determined. At 610, a first attribute and a second attribute are selected from the priority list. The first attribute has a first priority rank, the second attribute has a second priority rank, and the first priority rank is higher than the second priority rank. In some embodiments, the first priority rank is the highest priority rank among all priority ranks of the priority list. A first performance criterion may be associated with the first attribute, and a second performance criterion may be associated with the second attribute. For example, the first attribute is traffic, and the second attribute is load.

At 612, a first group of servers associated with the first attribute and a second group of servers associated with the second attribute are identified. At 614, the artifact or upgrade artifact are sequentially deployed on the first group of servers and the second group of servers, according to the priority ranks. In some embodiments, deployment of the artifact or upgrade artifact on the first group of servers is initialized on the first group of servers to meet the first performance criterion. In some embodiments, deployment of the artifact or upgrade artifact on the second group of servers is initialized after the artifact or upgrade artifact is deployed on the first group servers. Deployment of the artifact or upgrade artifact on the second group of servers is controlled to meet both the first and second performance criteria. In some embodiments, a sequence of servers or groups of servers of the cloud computing platform is determined, and the deployment or upgrade instance is configured for deployment of the artifact or upgrade artifact following the determined sequence.

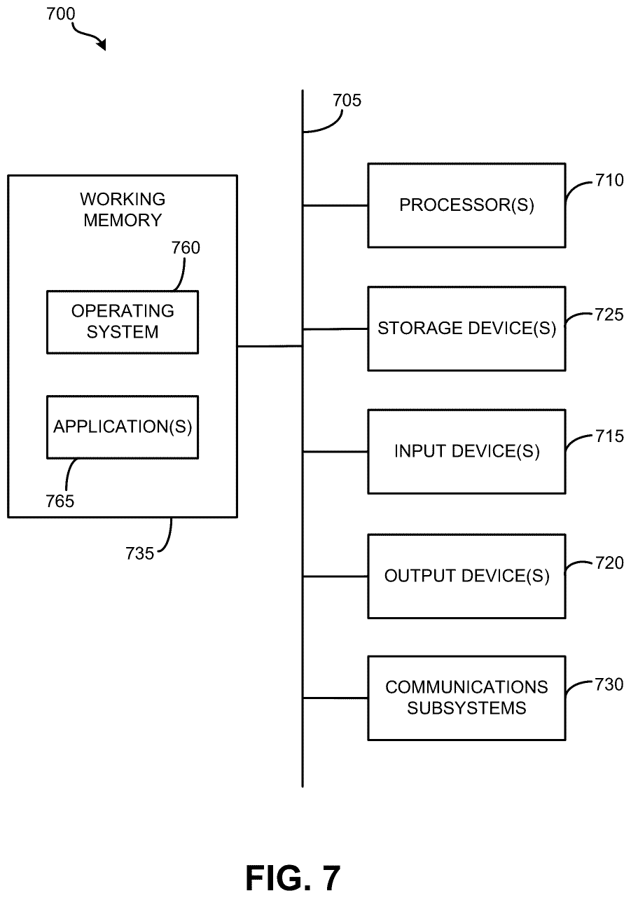

Various systems, architectures, topologies, devices, and components described herein included therein such as the service management system 402 as described above may include a computer system that further includes computer hardware and/or software that form special-purpose network circuitry to implement various embodiments such as communication, model construction, optimization, calculation, determination, and so on. FIG. 7 is a schematic diagram illustrating an example of computer system 700. The computer system 700 is a simplified computer system that can be used to implement various embodiments described and illustrated herein. A computer system 700 as illustrated in FIG. 7 may be incorporated into devices such as a portable electronic device, mobile phone, server grade machines, or other device as described herein. FIG. 7 provides a schematic illustration of one embodiment of a computer system 700 that can perform some or all of the steps of the methods and workflows provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown including hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, a 602.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g., the first electronic device, may be incorporated into the computer system 700, e.g., an electronic device as an input device 715. In some embodiments, the computer system 700 will further include a working memory 735, which can include a RAM or ROM device, as described above.

The computer system 700 also can include software elements, shown as being currently located within the working memory 735, including an operating system 760, device drivers, executable libraries, and/or other code, such as one or more application programs 765, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the operations of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, solid state drive, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a server” may include a plurality of such data servers, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A method comprising:
receiving an upgrade artifact to be deployed on a cloud computing platform, the cloud computing platform comprising a plurality of servers;
extracting a plurality of attributes from the upgrade artifact;
selecting a first attribute from the plurality of attributes;
determining a first performance criterion associated with the first attribute;
configuring an upgrade instance to meet the first performance criterion during deployment of the upgrade artifact;
identifying a first group of servers from the plurality of servers, the first group of servers associated with the first attribute; and
executing the upgrade instance to deploy the upgrade artifact on the first group of servers in a production environment.

2. The method of claim 1, further comprising:
validating the upgrade artifact before extracting the attributes.

3. The method of claim 1, further comprising:
testing the upgrade artifact in a test environment before deploying in the production environment.

4. The method of claim 1, further comprising:
monitoring real-time performance during deployment of the upgrade artifact; and
determining whether the real-time performance meets the first performance criterion.

5. The method of claim 1, further comprising:
prioritizing the plurality of attributes to generate a priority list; and
assigning a priority rank to each one of the attributes,
wherein the first attribute has a first priority rank.

6. The method of claim 5, wherein the first priority rank is the highest rank among all priority ranks assigned to the plurality of attributes, and the upgrade instance is configured to deploy the upgrade artifact on the first group of servers before other servers of the plurality of servers.

7. The method of claim 5, further comprising:
selecting a second attribute from the plurality of attributes, the second attribute having a second priority rank lower than the first priority rank;
determining a second performance criterion associated with the second attribute;
identifying a second group of servers from the plurality of servers, the second group of servers associated with the second attribute; and
executing the upgrade instance to deploy the upgrade artifact on the second group of servers in a production environment,
wherein the upgrade instance is configured to:
initialize deployment of the upgrade artifact on the second group of servers after the upgrade artifact is deployed on the first group of servers; and
meet both the first and second performance criterion during deployment of the upgrade artifact on the second group of servers when the upgrade instance is executed.

8. The method of claim 1, further comprising:
generating a deployment script for the upgrade instance.

9. The method of claim 1, wherein the first attribute is a network slice of a cellular network supported by the cloud computing platform, and the first performance criterion is a predetermined threshold of a total usage of bandwidth of the network slice during the deployment of the upgrade artifact on the first group of servers.

10. The method of claim 1, wherein the first attribute is network traffic of a network supported by the cloud computing platform, and the first performance criterion is a predetermined threshold of traffic flows during the deployment of the upgrade artifact on the first group of servers.

11. A system comprising:
one or more processors; and
a computer-readable storage media storing computer-executable instructions that, when executed by the one or more processors, cause the system to perform:
receiving an upgrade artifact to be deployed on a cloud computing platform, the cloud computing platform comprising a plurality of servers;
extracting a plurality of attributes from the upgrade artifact;
selecting a first attribute from the plurality attributes;
determining a first performance criterion associated with the first attribute;
configuring an upgrade instance to meet the first performance criterion during deployment of the upgrade artifact;
identifying a first group of servers from the plurality of servers, the first group of servers associated with the first attribute; and
executing the upgrade instance to deploy the upgrade artifact on the first group of servers in a production environment.

12. The system of claim 11, wherein, the instructions when executed by the one or more processors, further cause the system to perform:
validating the upgrade artifact before extracting the attributes.

13. The system of claim 11, wherein, the instructions when executed by the one or more processors, further cause the system to perform:
testing the upgrade artifact in a test environment before deploying in the production environment.

14. The system of claim 11, wherein, the instructions when executed by the one or more processors, further cause the system to perform:
monitoring real-time performance during deployment of the upgrade artifact; and
determining whether the real-time performance meets the first performance criterion.

15. The system of claim 11, wherein, the instructions when executed by the one or more processors, further cause the system to perform:
prioritizing the plurality of attributes to generate a priority list; and
assigning a priority rank to each one of the attributes,
wherein the first attribute has a first priority rank.

16. The system of claim 15, wherein the first priority rank is the highest rank among all priority ranks assigned to the plurality of attributes, and the upgrade instance is configured to deploy the upgrade artifact on the first group of servers before other servers of the plurality of servers.

17. The system of claim 15, wherein, the instructions when executed by the one or more processors, further cause the system to perform:
selecting a second attribute from the plurality of attributes, the second attribute having a second priority rank lower than the first priority rank;
determining a second performance criterion associated with the second attribute;
identifying a second group of servers from the plurality of servers, the second group of servers associated with the second attribute; and
executing the upgrade instance to deploy the upgrade artifact on the second group of servers in a production environment,
wherein the upgrade instance is configured to:
initialize deployment of the upgrade artifact on the second group of servers after the upgrade artifact is deployed on the first group of servers; and
meet both the first and second performance criterion during deployment of the upgrade artifact on the second group of servers when the upgrade instance is executed.

18. The system of claim 11, wherein, the instructions when executed by the one or more processors, further cause the system to perform:
generating a deployment script for the upgrade instance.

19. The system of claim 11, wherein the first attribute is a network slice of a cellular network supported by the cloud computing platform, and the first performance criterion is a predetermined threshold of a total usage of bandwidth of the network slice during the deployment of the upgrade artifact on the first group of servers.

20. The system of claim 11. wherein the first attribute is network traffic of a network supported by the cloud computing platform, and the first performance criterion is a predetermined threshold of traffic flows during the deployment of the upgrade artifact on the first group of servers.
